(19) United States
(12) Patent Application Publication
(10) Pub. No.: US 2021/0404213 A1
(43) Pub. Date: Dec. 30, 2021

(54) Invisible latch strike

(71) Applicant: Thomas Chenoweth, Fort Myers, FL (US)

(72) Inventor: Thomas Chenoweth, Fort Myers, FL (US)

(21) Appl. No.: 16/873,754

(22) Filed: Jun. 26, 2020

(51) Int. Cl. E05B 15/02

(52) U.S. Cl. CPC E05B 15/024

(57) ABSTRACT

An edge strike latch plate having a retraction means for retracting a door spring-loaded latch bolt wherein the retraction means proximates the front edge of a door jamb or proximates the front edge of door jamb architrave to protect the front edge of the door jamb and the front edge of architrave from a door spring-loaded latch bolt, protect from injury an individual, protect from damage the clothing of an individual, protect from damage the personal property of an individual, and protect pets from injury.

### BRIEF DESCRIPTION OF THE PRIOR ART

### Physical Description of Prior Art

Conventional interior door hardware kits include doorknobs or door handles, escutcheon plates, a spindle, a spring-loaded latch bolt mechanism mounted inside the door, and a bolt face plate. The kit also includes a latch plate that is mounted on the door jamb of a door frame opposite both the spring-loaded latch bolt and the bolt face place.

Conventional interior door latch plates are either a full lip latch plate or a T-strike lip latch plate. The latch plates are comprised of both a flat base portion and a curvature lip portion. The latch plate is mounted on the door jamb of a door frame using fastening screws inserted through apertures of the base plate portion. The door spring-loaded latch bolt mechanism operates with the complementary latch plate in the following manner: when an individual shuts a door inside a door frame, the front face of the angled bolt of the door spring-loaded latch bolt mechanism hits (strikes) the front face of the lip of the latch plate, thereby retracting the angled bolt inside of the door spring-loaded latch bolt mechanism. The door is completely shut when the angled bolt rests inside the base plate portion's opening for receiving the door spring-loaded latch bolt. To firmly shut the door against the door stop of the door frame and eliminate door rattle, the base plate portion has an adjustable tab inside the base plate portion's opening for receiving the door spring-loaded latch bolt.

### Category of Prior Art

Conventional door jamb latch plates are full lip latch plates and T-strike lip latch plates. Their category of prior art “lip strike latch plates” originates from the manner in which the door spring-loaded latch bolt and the complementary latch plate operate together. The angled bolt retracts inside the door spring-loaded latch bolt mechanism when the front face of the angled bolt hits (strikes) the front face of the curvature lip portion of the latch plate. Thus, convention door jamb latch plates are lip strike latch plates.

### Iterations of Prior Art

Conventional interior door latch plates comprise a stamped metal, single member having a flat base portion and a curvature lip portion. The conventional single member latch plates are either full lip latch plates or T-strike lip latch plates and are typically found in houses, apartments, and other residential buildings. Complex interior door latch plates comprise two or more members working together to perform similar functions of the conventional single member interior door latch plates.

### Objects of Prior Art

Conventional interior door latch plates serve three important functions. First, they work with spring-loaded latch bolt mechanisms to shut the door in the door frame, hold the door closed, and eliminate door rattle with the adjustable tab.

Second, they protect the door jamb of the door frame from the abrasive front face of the angled bolt of the door spring-loaded latch bolt mechanism wherein the flat base portion covers the door jamb, thereby eliminating dents and gouges in the door jamb.

Third, they protect the architrave surrounding the door frame from the abrasive front face of the angled bolt of the door spring-loaded latch bolt mechanism wherein the flat base portion and the curvature lip portion cover the front edge of the architrave, thereby eliminating dents and gouges in the front edge of the architrave.

Conventional interior door latch plates accomplish both the second and the third functions as follows: the “leading edge” of the flat base portion extends outwards away from the front edge of the door jamb, thereby protecting the door jamb. The curvature lip portion extends outwards away from the front edge of the architrave, thereby protecting the front edge of the architrave.

### RELEVANT PRIOR ART

Spencer, U.S. Pat. No. 849,895 A, Apr. 9, 1907, shows a door jamb latch plate comprising two portions, a portion having a latch bolt receiving opening and a right-angle mounting portion having apertures to affix the mounting portion to the front face of a door jamb architrave.

Christy, U.S. Pat. No. 872,053A, Nov. 26, 1907, shows an adjustable door jamb latch plate having a combination of two interlocking strike plates to horizontally reposition latch bolt receiving openings to coordinate with a door spring-loaded latch bolt and a deadbolt.

Upton, U.S. Pat. No. 987,271 A, Mar. 21, 1911, shows a door jamb latch plate wherein a metal plate covers the angled bolt of the door spring-loaded latch bolt mechanism in FIG. 4.

Wiley, U.S. Pat. No. 1,093,816 A, Apr. 21, 1914, shows an adjustable door jamb latch plate having a combination of two interlocking plates to vertically reposition latch bolt receiving openings to coordinate with a door spring-loaded latch bolt and a deadbolt.

Kennedy, U.S. Pat. No. 1,238,924 A, Sep. 4, 1917, shows an adjustable door jamb latch plate having one member with cutaways to vertically reposition latch bolt receiving openings to coordinate with a door spring-loaded latch bolt and a deadbolt.

Smith, U.S. Pat. No. 1,563,667 A, Dec. 1, 1925, shows an adjustable door jamb latch plate having a combination of two interlocking latch plates to horizontally reposition a latch bolt receiving opening to coordinate with a door spring-loaded latch bolt.

Karns, U.S. Pat. No. 1,733,412 A, Oct. 29, 1929, shows an adjustable door jamb latch plate having a combination of two interlocking members wherein one member is an adjustable tab.

Norring, U.S. Pat. No. 1,852,854 A, Apr. 5, 1932, shows an adjustable door jamb latch plate having a combination of two interlocking latch plates to horizontally reposition latch bolt receiving openings to coordinate with a door spring-loaded latch bolt and a deadbolt.

Snook, GB 430,369 A, Feb. 23, 1934, shows a template to position a door jamb latch plate but does not show the construction of a door jamb latch plate.

Goetz, U.S. Pat. No. 2,013,145 A, Sep. 3, 1935, shows an adjustable door jamb latch plate to horizontally reposition an elongated latch bolt receiving opening to coordinate with a door spring-loaded latch bolt and a deadbolt.

Tonks, GB 481,989 A, Nov. 11, 1936, shows a latch plate for a box or door wherein the latch plate comprises two portions, a latch bolt receiving opening portion and a front portion, both portions positioned at right angles to each other and both portions positioned in mortised areas of a box or a door frame.

Flora, U.S. Pat. No. 2,094,119 A, Sep. 28, 1937, shows an adjustable door jamb latch plate having a combination of two interlocking strike plates to horizontally and vertically reposition a latch strike plate to coordinate with a door spring-loaded latch bolt and the two interlocking latch plates having a small adjoining flat lip extending to approximately the front edge of a door jamb.

Flora, U.S. Pat. No. 2,153,080 A, Apr. 4, 1939, shows an adjustable door jamb latch plate having a combination of two interlocking latch plates to horizontally and vertically reposition a latch plate to coordinate with a door spring-loaded latch bolt and the two interlocking latch plates having a large adjoining flat lip extending to approximately the front edge of a door jamb.

Model, U.S. Pat. No. 2,231,414 A, Feb. 11, 1941, shows an adjustable door jamb latch plate having a combination of two members wherein one member is an adjustable tab.

Leary et al., U.S. Pat. No. 2,403,182 A, Jul. 2, 1946, shows an adjustable door jamb latch plate having two aperture opening gears to horizontally reposition latch bolt receiving openings to coordinate with a door spring-loaded latch bolt and a deadbolt.

Beckman, U.S. Pat. No. 2,446,206 A, Aug. 3, 1948, shows a door jamb latch plate comprising a front tab and a rear tab and a wear plate between the front edge of the latch plate and the front edge of a door jamb.

Miller, U.S. Pat. No. 2,535,444 A, Dec. 26, 1950, shows an adjustable door jamb latch plate having two members, a latch plate and an anti-rattle clip to coordinate with a door spring-loaded latch bolt.

Anstine, U.S. Pat. No. 2,572,428 A, Oct. 23, 1951, shows an adjustable door jamb latch plate to horizontally and vertically reposition latch bolt receiving openings to coordinate with a door spring-loaded latch bolt or deadbolt.

Bissot, U.S. Pat. No. 2,695,807 A, Nov. 30, 1954, shows an adjustable door jamb latch plate having a combination of two interlocking latch plates to horizontally reposition a latch bolt receiving opening to coordinate with a door spring-loaded latch bolt.

Gravino, U.S. Pat. No. 2,787,490 A, Apr. 2, 1957, shows an adjustable door jamb latch plate having a combination of two members, an inner plate and an outer plate wherein the outer plate having an elongated T-strike shape and the front edge of the outer plate extending to the front edge of a door jamb.

Wickstrom, U.S. Pat. No. 2,713,506 A, Jul. 19, 1955, shows an adjustable door jamb latch plate having a combination of two interlocking latch strike plates to horizontally reposition a latch bolt receiving opening to coordinate with a door spring-loaded latch bolt.

Russell, U.S. Pat. No. 2,798,754 A, Jul. 9, 1957; Russell, U.S. Pat. No. 3,241,873 A, Mar. 22, 1966; Russell, U.S. Pat. No. 3,257,139 A, Jun. 21, 1966; Russell, U.S. Pat. No. 3,361,466 A, Jan. 2, 1968; Russell, U.S. Pat. No. 3,416,829 A, Dec. 17, 1968; and Russell, U.S. Pat. No. 3,506,293 A, Apr. 14, 1970; show a door jamb latch plate having a combination of two interlocking latch plates to horizontally reposition a latch bolt receiving opening to coordinate with a door spring-loaded latch bolt.

Royalty, U.S. Pat. No. 3,006,677 A, Oct. 31, 1961, shows an adjustable door jamb latch plate having a combination of two members, a latch plate and a horizontally adjustable tab.

Rosenberger, U.S. Pat. No. 3,395,935 A, Aug. 6, 1968, shows an adjustable door jamb latch plate having a combination of two members, a latch plate and a horizontally adjustable tab.

Brandt et al., U.S. Pat. No. 3,401,487 A, Sep. 17, 1968, shows an adjustable door jamb latch plate having a combination of two members, a base plate and a horizontal sliding outer plate to coordinate the latch bolt receiving opening with a door spring-loaded latch bolt.

Russell et al., U.S. Pat. No. 3,506,293 A, April 1970, shows an adjustable door jamb latch plate having a combination of two members, a base plate and an adjustable outer plate to coordinate a latch bolt receiving opening with a door spring-loaded latch bolt.

Sushan, CA 856,109 A, Nov. 17, 1970, shows a T-shaped, elongated, entry door guard and elongated door jamb latch plate to prevent unauthorized unlocking of an exterior entry door spring-loaded latch bolt, using a plastic credit card.

Thiel, U.S. Pat. No. 4,105,235 A, Aug. 8, 1978, shows a combination of three interlocking door jamb latch plates to horizontally reposition a latch bolt receiving opening to coordinate with a door spring-loaded latch bolt.

St. Aubin, U.S. Pat. No. 4,171,836 A, Oct. 23, 1979, shows a combination of two interlocking door jamb latch plates, having vertical rows of teeth, to horizontally reposition a latch bolt receiving opening to coordinate with a door spring-loaded latch bolt.

Moore, U.S. Pat. No. 4,288,120 A, Sep. 8, 1981, shows a combination of two interlocking door jamb latch plates to horizontally reposition a latch bolt receiving opening to coordinate with a door spring-loaded latch bolt.

Allenbaugh, U.S. Pat. No. 4,492,397 A, Jan. 18, 1985, shows a combination of three members, a door jamb latch plate and two screw blocks, to horizontally reposition a latch bolt receiving opening to coordinate with a door spring-loaded latch bolt.

York, GB 2,245,305 A, Aug. 18, 1990, shows a combination of two members, a door jamb latch plate and a base plate, to horizontally reposition a latch bolt receiving opening to coordinate with a door spring-loaded latch bolt.

Nicholas, Jr. et al, U.S. Pat. No. 5,118,151 A, Jun. 2, 1992, shows a combination of five members, a door jamb latch plate and four other members, to horizontally and vertically reposition a latch bolt receiving opening to coordinate with a door spring-loaded latch bolt.

Komatsu, JP H08296353 A, Apr. 26, 1995, shows a combination of two members, a door jamb latch plate and a dust box for a latch bolt receiving opening, wherein the door jamb latch plate having a flat portion and a curvature portion, and the flat portion adjacent to the curvature portion having concave grooves to make the flat portion adjacent to the curvature portion easily malleable to bend the flat portion adjacent to the curvature portion to reposition the front edge of the curvature portion to be close to the front edge of a door frame.

Roth, U.S. Pat. No. 5,757,269 A, May 26, 1998, shows a door jamb latch plate wherein the curvature lip of the door jamb latch plate extending to the front edge of a door jamb.

Matsuno, JP 2001329723 A, May 22, 2000, shows a combination of three members, a door jamb latch plate and two other members to horizontally reposition a latch bolt receiving opening to coordinate with a door spring-loaded latch bolt.

Viatcheslav, DE 10216718 A1, Apr. 10, 2002, shows a door jamb latch plate having an anti-rattle spring inside a latch bolt receiving opening.

Theune et al., U.S. Pat. No. 6,588,155 B1, Jul. 8, 2003, shows a combination of four members, a door jamb latch plate and three other members to horizontally reposition a latch bolt receiving opening to coordinate with a door spring-loaded latch bolt.

Wagner et al., US 2004/0164565 A1, Aug. 26, 2004, shows a door jamb latch plate comprising an elongated flat portion and a curvature portion along the front edge of the elongated flat portion to protect from damage the front edge of a door jamb and protect from damage the front edge of a door jamb architrave.

Casey, U.S. Pat. No. 7,240,931 B1, Jul. 10, 2007, shows a combination of two members, a door jamb latch plate and a base plate, to horizontally reposition the door jamb latch plate to coordinate with a door spring-loaded latch bolt.

Gosterisli, US 2011/0175378 A1, Jul. 21, 2011, shows a combination of two interlocking door jamb latch plates to horizontally reposition a latch bolt receiving opening to coordinate with a door spring-loaded latch bolt.

Mullet, US 2012/028627 A1, Nov. 16, 2012, shows a combination of two interlocking door jamb latch plates to horizontally reposition a latch bolt receiving opening to coordinate with a door spring-loaded latch bolt.

Komiya, JP 2015010398 A, Jun. 28, 2013, shows a combination of five members, a door jamb latch plate and four other members, to horizontally reposition a latch bolt receiving opening to coordinate with a door spring-loaded latch bolt.

Sweeten, US 2015/0204107 A1, Jul. 23, 2015, shows a door jamb latch plate having an elongated latch bolt receiving opening to coordinate with a door spring-loaded latch bolt.

Magee, US 2016/0069105 A1, Mar. 10, 2016, shows a door jamb latch plate having two members, a door jamb latch plate and a base plate, wherein the front edge of the base plate having an edge on the back of the base plate wrapping around the front edge of a door jamb.

Fenwick, U.S. Pat. No. 9,822,550 A1, Nov. 21, 2017 and Fenwick, US 2018/0073272 A1, Mar. 15, 2018, show a door jamb latch plate having two members, a base plate and a lip constructed of flexible material affixed to the base plate.

Kamody, US 2018/0066449 A1, Mar. 8, 2018, shows templates to align a door jamb latch plate and a door spring-loaded latch bolt.

Moon, WO 2019/199066 A1, Oct. 17, 2019, shows a combination of three members, a door jamb latch plate and two other members, wherein the door jamb latch plate having a front edge extending to approximately the front edge of a door frame; a door frame includes both a door jamb and architrave covering the door jamb.

Alvarado, U.S. Pat. No. 10,544,602 B1, Jan. 28, 2020, shows a door jamb latch plate having a combination of two members, a lower plate and an upper plate to horizontally and vertically reposition a latch bolt receiving opening to coordinate with a door spring-loaded latch bolt.

Goldense, US 2020/0011126 A1, Jan. 9, 2020, shows a door jamb latch plate wherein the front leg of the door jamb latch plate wrapping around the front edge of a door jamb and the front leg of the door jamb latch plate having apertures to affix the front leg of the door jamb latch plate to the front edge of the door jamb with fasteners, including screws.

Deltana SP 225 door jamb latch plate shows a flat door jamb latch plate comprising a latch bolt receiving opening, an adjustable tab, and two apertures to affix the flat door jamb latch plate to a door jamb using fasteners, including screws, wherein the front edge of the flat door jamb latch plate extends ½ inch beyond the front edge of a door jamb for a 1⅜ inch thick interior door and extends ⅜ inch beyond the front edge of door jamb architrave having a front edge measuring ⅛ inch thick. (http://www.deltana.net)

Kwikset 83534-15 door jamb latch plate shows a combination of two members, a lower plate and an upper plate to horizontally reposition a latch bolt receiving opening to coordinate with a door spring-loaded latch bolt, wherein the front edge of the door jamb latch plate extends ½ inch to ¾ inch beyond the front edge of a door jamb for a 1⅜ inch thick interior door, and extends ⅜ inch to ⅝ inch beyond the front edge of door jamb architrave having a front edge measuring ⅛ inch thick. (http://www.doorlocksdirect.com/kwikset-adjustable-lip-strike-round-corner-2-1-4-h x-1-3-4-2-total-w-satin-nickel-83534-15/)

### BRIEF SUMMARY OF THE INVENTION

### Definitions

### Lip Strike Latch Plates

The term “lip strike latch plates” as used herein refers to prior art latch plates. Prior art latch plates, which include full lip latch plates and T-strike lip latch plates, are “lip strike latch plates” comprised of a flat base plate and a curvature lip, wherein the front face of the angled bolt of the door spring-loaded latch bolt mechanism hits (strikes) the front face of the curvature lip of the latch plates, thereby retracting the angled bolt inside of the door spring-loaded latch bolt mechanism. The lip strike latch plates have a lip that extends outwardly from the base plate, extending outwardly from the door jamb and extending outwardly from the front edge of the architrave, thereby protecting from dents and gouges both the door jamb and the front edge of architrave from direct contact with the angled bolt.

### Edge Strike Latch Plates

The term “edge strike latch plates” as used herein refers to present invention latch plates. Edge strike latch plates are comprised of a flat base plate, wherein the front face of the angled bolt of the door spring-loaded latch bolt mechanism hits (strikes) the front edge of the base plate, thereby retracting the angled bolt inside of the door spring-loaded bolt mechanism. For narrow-thickness architrave, the leading edge of the base plate proximates the front edge of the door jamb, thereby protecting from dents and gouges the door jamb from direct contact with the angled bolt. For wide-thickness architrave, the leading edge of the base plate can proximate the front edge of the wide-thickness architrave, thereby protecting from dents and gouges the both the door jamb and the architrave from direct contact with the angled bolt.

### Physical Description of the Present Invention

The present invention edge strike latch plates comprise a single member having a flat base plate and either a flat leading edge, a beveled leading edge, a rounded leading edge, or a flange. The present invention latch plates can be edge strike latch plates and T-strike edge strike latch plates.

### Objects of the Present Invention

The present invention latch plates perform five important functions. First, they work well with spring-loaded latch bolt mechanisms to shut the door in the door frame, hold the door closed, and eliminate door rattle with the optional adjustable tab.

Second, they protect the door jamb of the door frame from the abrasive front face of the angled bolt of the door spring-loaded latch bolt mechanism wherein the latch plate covers the door jamb, thereby eliminating dents and gouges in the door jamb.

Third, they protect narrow-thickness architrave surrounding the door jamb from the abrasive front face of the angled bolt of the door spring-loaded latch bolt mechanism wherein the angled bolt does not hit (strike) the front edge of the narrow-thickness architrave, thereby eliminating dents and gouges in the front edge of the architrave.

Narrow-thickness architrave is architrave having a front edge thickness measuring, for example, 1/32 inch, ⅛ inch, 3/16 inch, or ¼ inch. Given the construction industry standard one-quarter inch reveal between the front edge of the door jamb and the front edge of the architrave surrounding the door jamb, the front face of the angled bolt does not hit (strike) the front edge of the narrow-thickness architrave.

Fourth, they protect wide-thickness architrave surrounding the door jamb from the abrasive front face of the angled bolt of the door spring-loaded latch bolt mechanism using extended width edge strike latch strikes in instances where it is important to protect individuals from the physical hazard of the protruding lip of lip strike latch strikes.

Fifth, they protect individuals, clothing of individuals, personal property of individuals, and pets. Prior art lip strike latches have a protruding lip extending outwardly by approximately one-half inch beyond the front edge of the door jamb and the architrave. The protruding lip is a physical hazard. The present invention edge strike latch plates have no protruding lip. Thus, the present invention latch strikes protect individuals, clothing of individuals, personal property of individuals, and pets.

Spencer, U.S. Pat. No. 849,895 A, Apr. 9, 1907, shows a door jamb latch plate comprising two portions, a portion having a latch bolt receiving opening and a right-angle mounting portion having apertures to affix the mounting portion to the front face of door jamb architrave. Spencer's invention distinguishes from prior art to show a right-angle latch plate simultaneously covering a door jamb and door jamb architrave. Spencer fails to include in the description and fails to include in any claims of the invention to mention the latch plate only covering the door jamb.

Upton, U.S. Pat. No. 987,271, Mar. 21, 1911, shows a door jamb latch plate wherein the front edge of the latch plate wrapping around the front edge of a door jamb in FIG. 2 and FIG. 3. Upton's invention distinguishes from prior art to show a metal clip covering a spring-loaded latch bolt to enable an individual to close a door and open a door without turning the door handle. Upton fails to include in the description and fails to include in any four claims of the invention to mention physical features of the latch plate.

Flora, U.S. Pat. No. 2,094,119 A, Sep. 28, 1937, shows an adjustable door jamb latch plate having a combination of two interlocking latch plates to horizontally and vertically reposition a latch plate to coordinate with a door spring-loaded latch bolt and the two interlocking latch plates having a small adjoining flat lip extending to approximately the front edge of a door jamb. Flora's invention distinguishes from prior art to show a latch plate wherein an inner plate and an outer plate having horizontal and vertical teeth and the adjustment of the latch bolt receiving openings are independent of the surrounding latch plate. Flora fails to include in the description and fails to include in any seven claims of the invention to mention a latch plate that has the basic features of a latch plate.

Flora, U.S. Pat. No. 2,153,080 A, Apr. 4, 1939, shows an adjustable door jamb latch plate having a combination of two interlocking latch plates to horizontally and vertically reposition a latch plate to coordinate with a door-spring loaded latch bolt and the two interlocking latch plates having a large adjoining flat lip extending to approximately the front edge of a door jamb. Flora's invention distinguishes from prior art to show a latch plate wherein an inner plate and an outer plate having horizontal and vertical teeth and the adjustment of the latch bolt receiving openings are independent of the surrounding latch plate and further the invention having a dust box. Flora fails to include in the description and fails to include in any four claims of the invention to mention a latch plate having the basic features of a latch plate.

Model, U.S. Pat. No. 2,231,414 A, Feb. 11, 1941, shows an adjustable door jamb latch plate having a combination of two members wherein one member is an adjustable tab. Model distinguishes from prior art to show a cam wheel to reposition an adjustable tab. Model fails to include in the description and fails to include in any of three claims of the invention to mention a latch plate having the basic features of a latch plate.

Beckman, U.S. Pat. No. 2,446,206 A, Aug. 3, 1948, shows a door jamb latch plate comprising a front tab, a rear tab, and a wear plate between the front edge of the latch plate and the front edge of a door jamb. Beckman's invention distinguishes from prior art to show a latch plate having inside of a latch bolt receiving opening both a front tab and a rear tab. Beckman fails to include in any of claims of the invention to mention the physical features of the latch plate, except the front tab and the rear tab.

Miller, U.S. Pat. No. 2,535,444 A, Dec. 26, 1950, shows an adjustable door jamb latch plate having two members, a latch plate and an anti-rattle clip to coordinate with a door spring-loaded latch bolt. Miller's invention distinguishes from prior art to show an anti-rattle clip attached to a latch plate. Miller fails to include in the description and fails to include in any of three claims of the invention to mention the physical features of the latch plate, except the anti-rattle clip.

Gravino, U.S. Pat. No. 2,787,490 A, Apr. 2, 1957, shows an adjustable door jamb latch plate having a combination of two members wherein the inner plate having a repositioning latch bolt receiving opening and the outer plate having an elongated T-strike shape and the front edge of the outer plate extending to the front edge of a door jamb. FIG. 1 and FIG. 2 show an outer plate having an elongated T-strike shape and the front edge of the outer plate extending to the front edge of a door jamb. Gravino fails to include in the description and fails to include in any claims of the invention to mention the physical features of the outer plate, except the outer plate having a T-shape and secured within the typical recessed portion of a door jamb.

Komatsu, JP 1408296353 A, Apr. 26, 1995, shows a door jamb latch plate that makes an attempt to minimize injury to an individual, makes an attempt to minimize damage to clothing of an individual, and makes an attempt to minimize damage to personal property of an individual. Komatsu shows a door jamb latch plate comprising a flat portion and a curvature portion wherein the flat portion having etched concave grooves to make the flat portion easily malleable to move the front edge of the curvature portion close to the contour of a door frame architrave. Komatsu suggests an individual use a hammer to bend the flat portion. The front edge of the curvature portion of the door jamb latch plate may cause injury to an individual, may cause damage to the clothing of an individual, and may cause damage to the personal property of an individual because an open area may exist between the front edge of the curvature portion and the contour of the door frame architrave. Komatsu fails to include in the description and fails to include in any six claims a latch plate having a front edge extending to the front edge of a door jamb.

Roth, U.S. Pat. No. 5,757,269 A, May 26, 1998, shows a door jamb latch plate wherein the curvature lip of the latch plate extending to the front edge of a door jamb. Roth's invention distinguishes from prior art to show an electronic detection system to monitor the opening and closing of a door. Roth fails to include in the description and fails to include in any five claims to mention a latch plate having the basic features of a latch plate.

Matsuno, JP 2001329723 A, May 22, 2000, shows a combination of three members, a door jamb latch plate and two other members to horizontally reposition a latch bolt receiving opening to coordinate with a door spring-loaded latch bolt. Matsuno distinguishes from prior art to show a latch bolt receiving opening repositioning independently of the latch plate. Matsuno fails to include in the description and fails to include in any three claims to mention a latch plate having a front edge extending to the front edge of a door jamb.

Wagner et al., US 2004/0164565 A1, Aug. 26, 2004, shows a door jamb latch plate comprising an elongated flat portion and a curvature portion along the front edge of the elongated flat portion to protect from damage the front edge of a door jamb and protect from damage the front edge of door jamb architrave. Wagner's invention distinguishes from prior art to show an elongated latch plate. Wagner fails to include in the description and fails to include in any fifteen claims to mention a latch plate having a front edge extending to the front edge of a door jamb.

Komiya, JP 2015010398 A, Jun. 28, 2013, shows a combination of five members, a door jamb latch plate and four other members, to horizontally reposition a latch bolt receiving opening to coordinate with a door spring-loaded latch bolt. Komiya's invention distinguishes from prior art to show latch plate having two members repositioning independently of each other to coordinate with a door spring-loaded latch bolt. Komiya fails to include in the description and fails to include in any five claims to mention a latch plate having a front edge extending to the front edge of a door jamb.

Magee, US 2016/0069105 A1, Mar. 10, 2016, shows a door jamb latch plate having two members, a base plate and a latch plate, wherein the front edge of the base plate having an edge on the back of the base plate wrapping around the front edge of a door jamb. Magee's invention distinguishes from prior art to show an elongated base plate on which to affix a latch plate. Magee fails to include in the description and fails to include in any fourteen claims to mention a latch plate having a front edge extending to the front edge of a door jamb.

Fenwick, U.S. Pat. No. 9,822,550 B2, Nov. 21, 2017, shows a door jamb latch plate that makes an attempt to minimize injury to an individual, makes an attempt to minimize damage to clothing of an individual, and makes an attempt to minimize damage to personal property of an individual. Fenwick shows a door jamb latch strike comprising two members, a base member constructed of metal and a curvature member constructed of flexible material. Fenwick shows a door jamb latch plate having both the curvature member and the front edge of the curvature member extending beyond both the front edge of a door jamb and the front edge of a door jamb architrave. The flexible material of the curvature portion may prevent cuts to an individual and may prevent gouges to the personal property of an individual. However, the exposed curvature portion of the flexible material may cause bruises or sprains to an individual, may cause stretches and tears to clothing of an individual, and may cause scuff marks to personal property of an individual. And further, Fenwick fails to include in the description and fails to include in any fifteen claims to mention a latch plate having a front edge extending to the front edge of a door jamb.

Moon, WO 2019/199066 A1, Oct. 17, 2019, shows a door jamb latch plate that makes an attempt to minimize injury to an individual and makes an attempt to minimize damage to clothing of an individual. Moon shows a door jamb latch plate comprising three members, a latch plate and two other members, wherein the latch plate having a front edge extending to approximately the front edge of a door frame. Moon shows a latch plate wherein the front edge of the latch plate extending to the front edge of a door frame and the front edge of the latch plate having three front edges: a front flat upper edge, a front flat lower edge, and a front curvature middle edge. Moon shows a door jamb latch plate to protect individuals and to protect the clothing of individuals. However, Moon shows a door jamb latch plate that is complex to manufacture and is complex to install. Further, the front edge of the latch plate may cause injury to an individual and may cause damage to clothing of an individual at the two intersections between the two front flat edges and the front curvature edge. Moon fails to include in the description and fails to include in any three claims to mention a single member latch plate having the basic features of a latch plate.

Goldense, US 2020/0011126 A1, Jan. 9, 2020, shows a door jamb latch plate wherein the wide front edge of the latch plate wrapping around the front edge of a door jamb. FIGS. 1, 2, 3, 4, 18, 23, and 24 show the front edge of the latch plate wrapping around the front edge of a door jamb. Goldense distinguishes from prior art to show a latch plate having non-flammable features. Goldense fails to include in the description and fails to include in any twenty-six claims to mention physical features of the latch plate, except the non-flammable features of the latch plate.

Therefore, a need exists for the present invention that protects an individual from injury, protects the clothing of an individual from damage, protects the personal property of an individual from damage, protects pets from injury, is simple and inexpensive to manufacture, and is simple and inexpensive to install.

### DESCRIPTION OF PREFERRED EMBODIMENTS

One embodiment of the present invention is an edge strike latch plate comprising a single member flat base plate having an opening for receiving the angled bolt of a door spring-loaded latch bolt mechanism, apertures for securing the base plate to the door jamb using screws, a retraction means for retracting the angled bolt of a door spring-loaded latch bolt mechanism, and the retraction means proximating the front edge of the door jamb.

Another embodiment of the present invention is an edge strike latch plate comprising a single member flat base plate having an opening for receiving the angled bolt of a door spring-loaded latch bolt mechanism, apertures for securing the base plate to the door jamb using screws, an optional adjustable tab for firmly shutting the door against the door stop of the door frame to eliminate door rattle, a retraction means for retracting the angled bolt of a door spring-loaded latch bolt mechanism, and the retraction means proximating the front edge of the door jamb.

An additional embodiment of the present invention is a T-strike edge strike latch plate comprising a single member flat base plate having an opening for receiving the angled bolt a door spring-loaded latch bolt mechanism, apertures for securing the base plate to the door jamb using screws, a retraction means for retracting the angled bolt of a door spring-loaded latch bolt mechanism, and the retraction means proximating the front edge of the doorjamb.

And a further embodiment of the present invention is a T-strike edge strike latch strike comprising a single member flat base plate having an opening for receiving the angled bolt of a door spring-loaded latch bolt mechanism, apertures for securing the base plate to the door jamb using screws, an optional adjustable tab for firmly shutting the door against the door stop of the door frame to eliminate door rattle, a retraction means for retracting the angled bolt of a door spring-loaded latch bolt mechanism, and the retraction means proximating the front edge of the door jamb.

The present invention edge strike latch plate may be constructed of stamped metal or plastic, or thick metal or thick plastic for additional strength. Further, the present invention may have a protective veneer coating, a plastic piece, or a plastic covering to protect the latch plate from wear and tear caused by the abrasive front face of the angled bolt of the door spring-loaded latch bolt mechanism. The stamped metal or plastic, protective veneer coating, plastic piece, and plastic covering are in prior art latch plates.

The retraction means of the edge strike latch plate or the retraction means of the T-strike edge strike latch plate is the leading edge of the edge strike latch plate selected from the group consisting of a flat edge, a beveled edge, a rounded edge, and a flange. The purpose of the flange is to hide from view the imperfect chiseled gouges of the mortise in which the base plate of the edge strike latch plate is inset flush with the door jamb. The imperfect chiseled gouges are made by a finish carpenter, a factory machine, or an unskilled individual.

Edge strike latch plates can be constructed from conventional lip strike latch plates, e.g., full lip latch plates and a T-strike lip latch plates. The lip strike latch plates are modified such that the angled bolt of the door spring-loaded latch bolt mechanism hits (strikes) the leading edge of the modified lip strike latch strikes. For full-lip lip strike latch plates, the protruding lip is replaced with a flat edge, a beveled edge, a rounded edge, or a flange. For T-strike lip strike latch plates, the protruding lip is replaced with a flat edge, a beveled edge, a rounded edge, or a flange. The protruding lip portion is any portion of the lip strike latch plates that extends beyond the front edge of the door jamb.

The retraction means may be referred to as the retraction means for retracting the angled bolt of the door spring-loaded latch bolt mechanism or the front edge striker for retracting the angled bolt of the door spring-loaded latch bolt mechanism.

The above and other objects, features and advantages of the present invention edge strike latch plate should become even more readily apparent to those skilled in the art upon a reading of the following detailed description in conjunction with the drawings wherein there is shown and described illustrative embodiments of the invention.

### Advantages of Invention Over Prior Art

One of the advantages of the present invention edge strike latch plates over prior art lip strike latch plates is protecting individuals, clothing of individuals, personal property of individuals, and pets from the physical hazard of the protruding lip of prior art lip strike latch plates. The present invention latch plates, not having a protruding lip, protects an individual's fingers, hands, arms, waist, and legs from scratches and cuts; protects an individual's long-sleeve shirt cuffs, long-sleeve shirt sleeves, pants waistbands, pants pockets, and pants legs from rips and tears; protects an individual's personal property including furniture from dents and gouges; and protects an individual's pets from scratches and cuts.

Another advantage of present invention edge strike latch plates is they work just as well as prior art lip strike latch plates with the retraction of the angled bolt of the door spring-loaded latch bolt mechanism. Door hardware companies state that latch plates need a protruding lip in order to function properly with door spring-loaded latch bolt mechanisms, thereby successfully retracting the angled bolt of the door spring-loaded latch bolt mechanism. However, the present invention latch plates having no protruding lip, also function properly with door spring-loaded latch bolt mechanisms.

A further advantage of the present invention edge strike latch plates is they work just as well as prior art lip strike latch plates protecting from dents and gouges the front edge of the door jamb. The front edge of the door jamb does not have direct contact with the angled bolt of the door spring-loaded latch bolt mechanism. The leading edge of the edge strike latch plates proximate the front edge of the door jamb, thereby protecting the front edge of the door jamb from direct contact with the angled bolt of the door spring-loaded latch bolt mechanism.

And another advantage of the present invention edge strike latch plates is they work just as well as prior art lip strike latch plates protecting from dents and gouges the front edge of architrave. For narrow-thickness architrave, the front edge of the architrave has no direct contact with the angled bolt of the door spring-loaded latch bolt mechanism. For wide-thickness architrave, installing extended width edge strike latch strikes, the front edge of the architrave has no direct contact with the angled bolt of the door spring-loaded latch bolt mechanism.

Additional advantages of the present invention edge strike latch plates are as follows: they are simple and inexpensive to manufacture, and simple and inexpensive to install. Compared to prior art lip strike latch plates, the present invention uses less raw materials, has fewer manufacturing steps, and is quickly and easily installed with screws provided by the manufacturer.

### BRIEF DESCRIPTION OF DRAWINGS

In the following detailed description, reference will be made to the attached drawings in which:

FIG. 1A is a front perspective plan view of the present invention edge strike latch plate wherein the retraction means, front edge striker having a flat edge and the retraction means, front edge striker proximating the front edge of the door jamb;

FIG. 1B is a side perspective plan view of the present invention edge strike latch plate of FIG. 1A;

FIG. 2A is a front perspective plan view of the edge strike latch plate of FIG. 1A wherein the retraction means, front edge striker having a beveled edge;

FIG. 2B is a side perspective plan view of the edge strike latch plate of FIG. 2A.

FIG. 3A is a front perspective plan view of the edge strike latch plate of FIG. 1A wherein the retraction means, front edge striker having a rounded edge;

FIG. 3B is a side perspective plan view of the edge strike latch plate of FIG. 3A;

FIG. 4A is a front perspective plan view of the edge strike latch plate of FIG. 1A wherein the retraction means, front edge striker having a flange;

FIG. 4B is a side perspective plan view of the edge strike latch plate of FIG. 4A; and

FIGS. 5A through 5H are cross sections of a sample of door jamb architraves having eight different profiles.

### DETAILED DESCRIPTION OF THE INVENTION

For purposes of describing the preferred embodiments, the terminology used in reference to the numbered accessories in the drawings is as follows:
100 Edge strike latch plate
110 Upper edge
120 Lower edge
130 Rear edge
140 Retraction means, front edge striker
142 Flat edge
144 Beveled edge
146 Rounded edge
148 Flange
170 Adjustable tab
180 Opening for receiving a spring-loaded latch bolt
190 Upper aperture
192 Lower aperture
200 Door jamb
210 Front edge of a door jamb
220 Rear edge of a door jamb
230 Drilled hole of a door jamb for receiving a spring-loaded latch bolt
300 Door stop
400 Architrave
410 Front edge of architrave
420 Rear edge of architrave
500 Dry wall
600 Stud

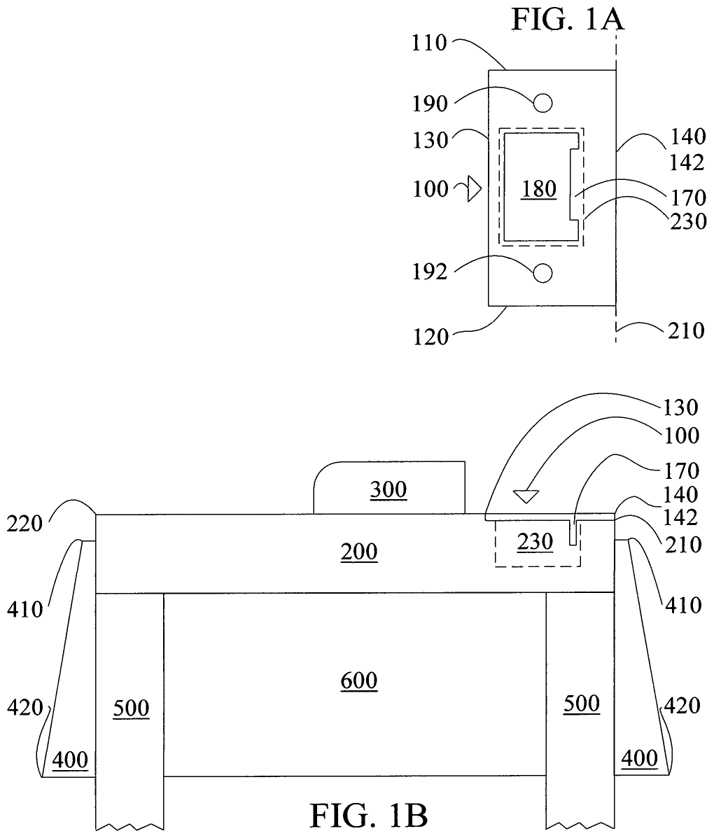

FIG. 1A shows a front perspective plan view of the present invention edge strike latch plate 100 comprising an upper edge 110, a lower edge 120, a rear edge 130, a retraction means, front edge striker 140 having a flat edge 142, an upper aperture 190 and a lower aperture 192 for fastening with screws the edge strike latch plate 100 to a door jamb 200, an opening for receiving a spring-loaded latch bolt 180, and an adjustable tab 170.

FIG. 1A also shows the retraction means, front edge striker 140 of the present invention edge strike latch plate 100 proximating the front edge of the door jamb 210 and further shows a drilled hole of the door jamb for receiving a spring-loaded latch bolt 230.

FIG. 1B shows a side perspective plan view of the present invention edge strike latch plate 100 of FIG. 1A. FIG. 1B shows the edge strike latch plate 100 comprising a rear edge 130 and a retraction means, front edge striker 140 having a flat edge 142, an opening for receiving a spring-loaded latch bolt 180, and an adjustable tab 170.

FIG. 1B also shows the present invention edge strike latch plate 100 attached to a door frame comprising a door jamb 200 and the rear edge of the door jamb 220 and the front edge of the door jamb 210, a drilled hole of the door jamb for receiving a spring-loaded latch bolt 230, a door stop 300, the architrave 400 and the front edge of architrave 410 and the rear edge of architrave 420, dry wall 500, and a stud 600.

FIG. 1B highlights the retraction means, front edge striker 140 proximating the front edge of the door jamb 210. FIG. 1B shows the retraction means, front edge striker 140 having a flat edge 142, and the edge strike latch plate 100 working with narrow-thickness architrave 400 having the front edge of architrave 410 measuring approximately one-eighth-inch thick.

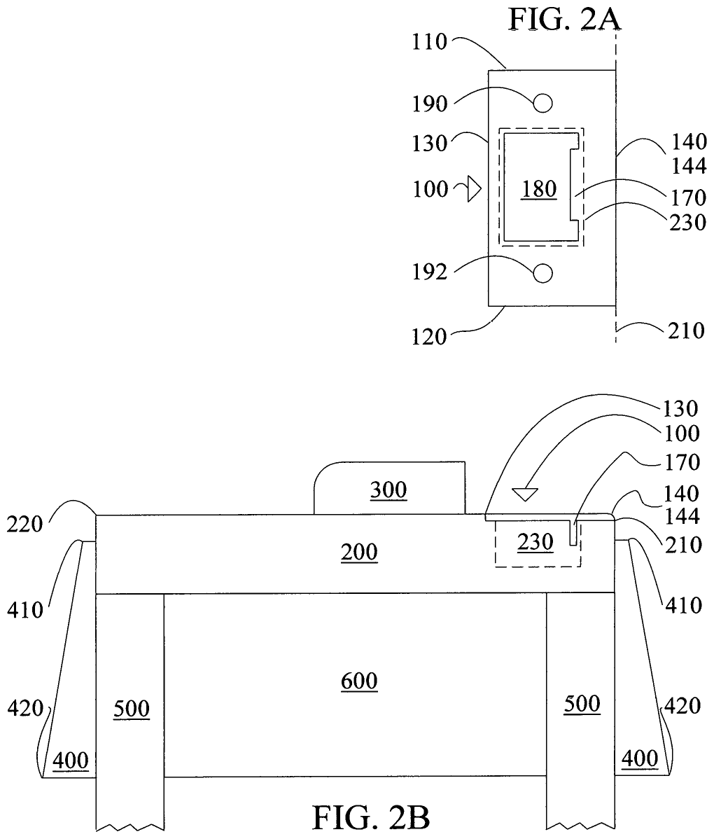

FIG. 2A shows a front perspective plan view of the present invention edge strike latch plate 100 of FIG. 1A wherein the retraction means, front edge striker 140 having a beveled edge 144.

FIG. 2B shows a side perspective plan view of the present invention edge strike latch plate 100 of FIG. 2A.

FIG. 2B highlights the retraction means, front edge striker 140 proximating the front edge of the door jamb 210. FIG. 2B shows the retraction means, front edge striker 140 having a beveled edge 144, and the edge strike latch plate 100 working with narrow-thickness architrave 400 having the front edge of architrave 410 measuring approximately one-eighth-inch thick.

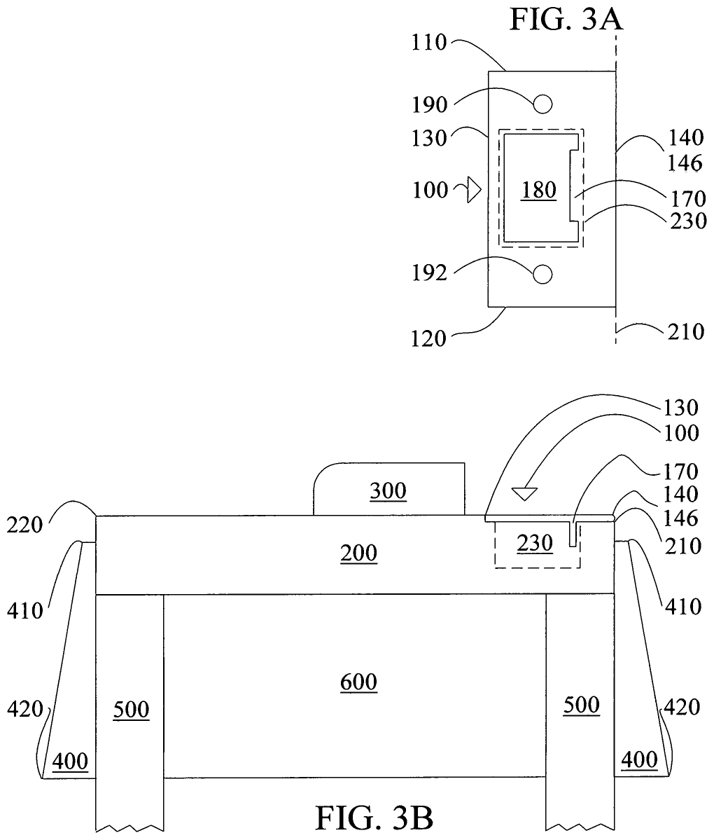

FIG. 3A shows a front perspective plan view of the present invention edge strike latch plate 100 of FIG. 1A wherein the retraction means, front edge striker 140 having a rounded edge 146.

FIG. 3B shows a side perspective plan view of the present invention edge strike latch plate 100 of FIG. 3A.

FIG. 3B highlights the retraction means, front edge striker 140 proximating the front edge of the door jamb 210. FIG. 3B shows the retraction means, front edge striker 140 having a rounded edge 146, and the edge strike latch plate 100 working with narrow-thickness architrave 400 having the front edge of architrave 410 measuring approximately one-eighth-inch thick.

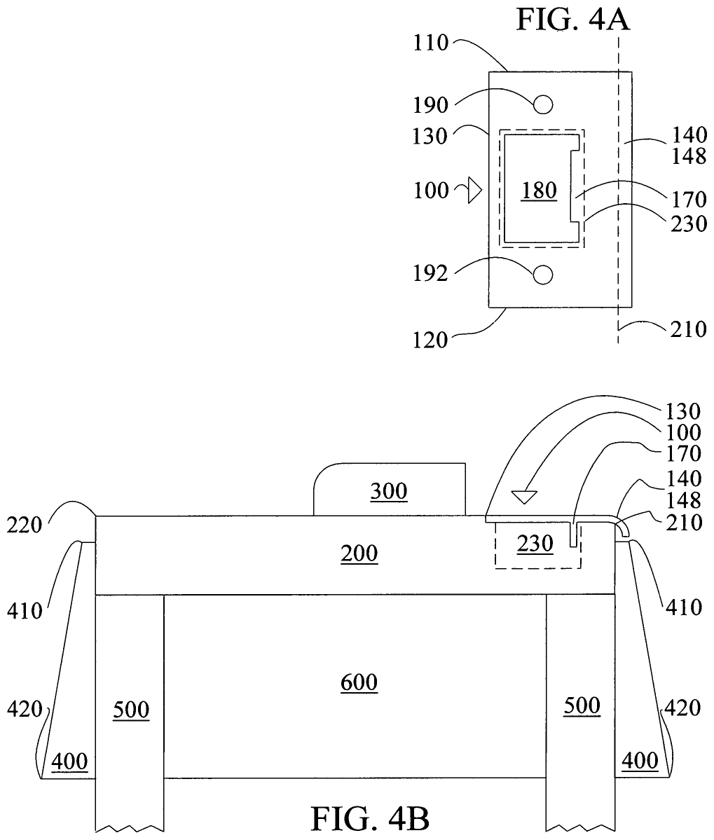

FIG. 4A shows a front perspective plan view of the present invention edge strike latch plate 100 of FIG. 1A wherein the retraction means, front edge striker 140 having a flange 148.

FIG. 4B shows a side perspective plan view of the present invention edge strike latch plate 100 of FIG. 4A.

FIG. 4B highlights the retraction means, front edge striker 140 proximating the front edge of the door jamb 210. FIG. 4B shows the retraction means, front edge striker 140 having a flange 148, and the edge strike latch plate 100 working with narrow-thickness architrave 400 having the front edge of architrave 410 measuring approximately one-eighth-inch thick.

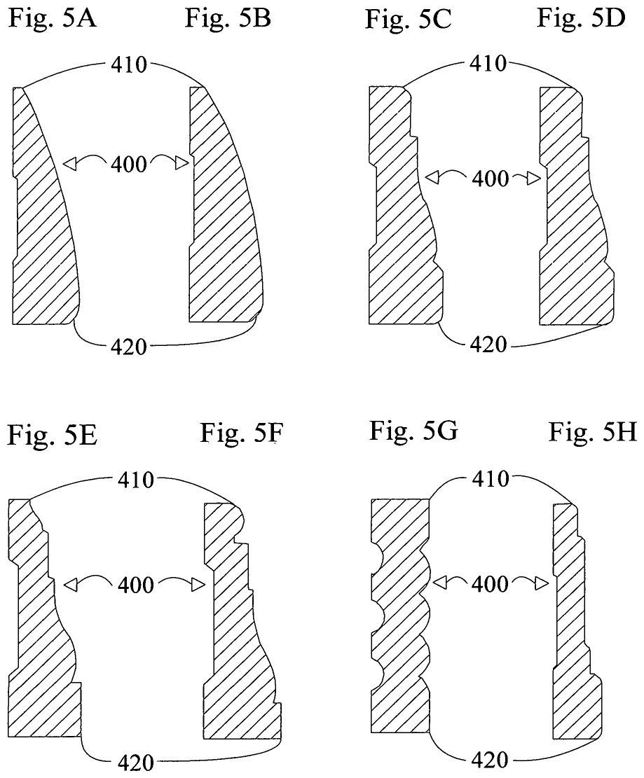

FIGS. 5A through 5H show cross sections of sample architraves 400 having eight different profiles. FIG. 5A shows the front edge of architrave 410 having a narrow-thickness front edge measuring one-eighth-inch thick; FIG. 5B, FIG. 5E, and FIG. 5H show the front edge of architrave 410 having a narrow-thickness front edge measuring three-sixteenths-inch thick; FIG. 5C and FIG. 5D show the front edge of architrave 410 having a narrow-thickness front edge measuring three-eighths-inch thick; FIG. 5F shows the front edge of architrave 410 having a narrow-thickness front edge measuring one-quarter-inch thick; and FIG. 5G shows the front edge of architrave 410 having a wide-thickness front edge measuring one-half-inch thick.

The foregoing description and accompanying figures illustrate the principles, preferred embodiments, and modes of operation of the invention. However, the invention should not be construed as being limited to the particular embodiments described above. Additional variations of the embodiments discussed above will be appreciated by those skilled in the art.

Therefore, the above-described embodiments should be regarded as illustrative rather than restrictive. Accordingly, it should be appreciated that variations of those embodiments can be made by those skilled in the art without departing from the scope of the invention as defined by the following claims.

### EXHIBIT 1. REFERENCES TO RELEVANT PRIOR ART

### U.S. Patent Documents

| | Issue/Publication | | |
|---|---|---|---|
| Patent No. | Date | Inventor | Classification |
| 47,741 A | May 1885 | Morris | E05B 17/007 |
| | | | 292/341.11 |
| 151,359 A | May 1874 | Davies | E05B 17/0045 |
| | | | 16/86 A |
| 201,572 A | March 1878 | Taylor | E05B 17/007 |
| | | | 292/341.11 |
| 213,967 A | April 1879 | Blackwood | E05B 17/007 |
| | | | 292/341.11 |
| 539,969 A | May 1895 | Wells | E05B 17/007 |
| | | | 292/341.11 |
| 749,818 A | January 1904 | Hamel | E05B 15/0245 |
| 769,770 A | September 1904 | Phelps | E05B 15/0245 |
| 839,556 A | December 1906 | Cuff | E05B 15/0245 |
| | | | 292/341.18 |
| 849,865 A | April 1907 | Spencer | E05B 15/0205 |
| 851,109 A | April 1907 | Swift | E05B 15/0205 |
| | | | 292/341.11 |
| 852,553 A | May 1907 | Georgenson et al. | E05B 15/0245 |
| | | | 292/341.19 |
| 872,053 A | November 1907 | Christy | E05B 15/0245 |
| 890,613 A | June 1980 | Cuff | E05B 15/0245 |
| 987,271 A | March 1911 | Upton | B41J 29/02 |
| | | | H04N 1/00525 |
| 1,005,914 A | October 1911 | Witman | E05B 15/0245 |
| 1,022,222 A | April 1912 | Augenbraun | E05B 15/0245 |
| 1,059,530 A | April 1913 | Dupuis | E05B 15/0245 |
| 1,093,816 A | April 1914 | Wiley | E05B 15/0245 |
| 1,111,425 A | September 1914 | Ziganek et al. | E05B 15/0245 |
| 1,194,636 A | August 1916 | Joy | E05B 17/08 |
| | | | 292/137 |
| 1,194,637 A | August 1916 | Joy | E05B 17/007 |
| | | | 292/341.11 |
| 1,214,227 A | January 1917 | Schwenk | E05B 15/02 |
| | | | E05B 15/245 |
| | | | 292/340 |
| 1,238,924 A | September 1917 | Kennedy | E05B 15/0245 |
| 1,245,617 A | November 1917 | Prinzler | E05B 15/0245 |
| 1,295,458 A | February 1919 | Erffmeyer | E05B 15/0245 |
| | | | 292/341.19 |
| 1,297,528 A | March 1919 | Wright | E05B 15/0245 |
| 1,336,505 A | April 1920 | Buggeln | E05B 67/383 |
| 1,458,637 A | June 1923 | Anderson | E05B 15/02 |
| | | | E05B 15/0245 |
| 1,463,384 A | July 1923 | Butterworth | E05B 15/025 |
| 1,488,620 A | April 1924 | Shaw | E05B 15/025 |
| 1,495,371 A | May 1924 | Witten | E05B 15/022 |
| | | | 292/238 |
| 1,497,044 A | June 1924 | Terrell | E05B 17/007 |
| | | | 292/163 |
| 1,563,667 A | December 1925 | Smith | E05B 15/025 |
| | | | 292/341.18 |
| 1,595,046 A | August 1926 | Martin | E05B 15/02 |
| | | | E05B 15/0245 |
| 1,611,973 A | December 1926 | Williams | E05B 15/02 |
| | | | E05B 15/0245 |
| 1,624,568 A | April 1927 | James | E05B 15/02 |
| | | | E05B 15/0245 |
| 1,630,533 A | May 1927 | Lundberg | E05B 15/02 |
| | | | E05B 15/0245 |
| 1,634,814 A | July 1927 | Williams | E05B 15/02 |
| | | | E05B 15/024 |
| 1,655,556 A | January 1928 | Marshall | E05B 15/0245 |
| 1,663,300 A | March 1928 | Halper | E05B 63/244 |
| | | | 292/341.17 |
| 1,688,626 A | October 1928 | Kissinger | E05B 15/0245 |
| 1,723,305 A | August 1929 | Sipe | E05C 19/002 |
| | | | 16/86 A |
| 1,733,412 A | October 1929 | Karns | E05B 15/02 |
| | | | 292/341.18 |
| 1,748,613 A | February 1930 | Ottinger | E05B 15/02 |
| | | | E05B 15/022 |
| 1,778,299 A | October 1930 | Ottinger | E05B 15/022 |
| 1,793,115 A | February 1931 | Model | E05B 15/02 |
| | | | E05B 15/025 |
| 1,852,854 A | April 1932 | Norring | E05B 15/024 |
| 1,886,494 A | November 1932 | Mitchell | E05B 15/0255 |
| 1,913,986 A | June 1933 | Harward | E05B 15/0245 |
| 1,913,444 A | June 1933 | Herdeg | E05B 15/025 |
| | | | 292/341.18 |
| 2,013,145 A | September 1935 | Goetz | E05B 15/024 |
| | | | 292/340 |
| 2,042,024 A | May 1936 | Schlage | E05B 15/0205 |
| | | | 292/340 |
| 2,127,891 A | August 1938 | Starling | E05B 17/2003 |
| | | | 292/346 |
| 2,065,732 A | December 1936 | Peace | E05B 15/02 |
| | | | E05B 15/0245 |
| | | | 292/340 |
| 2,086,049 A | July 1937 | Schlaman | E05B 15/0245 |
| | | | 292/340 |
| 2,094,119 A | September 1937 | Flora | E05B 15/02 |
| | | | 292/340 |
| 2,153,080 A | April 1939 | Flora | E05B 15/0245 |
| | | | 292/340 |
| 2,231,414 A | February 1941 | Model | E05B 15/024 |
| | | | 292/340 |
| 2,272,241 A | February 1942 | Fendring | E05B 15/0205 |
| | | | 292/340 |
| 2,350,635 A | June 1944 | Pendleton | E05B 15/0245 |
| | | | 292/341.18 |
| 2,370,781 A | March 1945 | Cullum | E05B 17/2003 |
| | | | 292/341.18 |
| 2,401,854 A | June 1946 | Berry, Jr. | E05B 15/02 |
| | | | E05B 15/0245 |
| | | | 292/340 |
| 2,403,182 A | July 1946 | Leary et al. | E05B 15/0245 |
| | | | 292/340 |
| 2,412,497 A | December 1946 | Edwards | E05B 15/025 |
| | | | 292/340 |
| 2,439,036 A | April 1948 | Bohnsack | E05B 15/0245 |
| | | | 292/340 |
| 2,446,206 A | August 1948 | Beckman | E05B 15/02 |
| | | | E05B 15/0255 |
| | | | 292/341.12 |
| 2,604,347 A | March 1949 | Snyder | E05B 15/0205 |
| | | | 292/340 |
| 2,503,536 A | April 1950 | Yeakel | E05B 15/025 |
| | | | 292/340.18 |
| 2,523,952 A | September 1950 | Heinen | E05B 15/02 |
| | | | E05B 15/0245 |
| | | | 292/340.18 |
| 2,535,444 A | December 1950 | Miller | E05B 15/0255 |
| | | | 292/341.13 |
| 2,572,428 A | October 1951 | Anstine | E05B 15/0245 |
| | | | 292/341.18 |
| 2,592,274 A | April 1952 | Groeger | E05B 15/0245 |
| | | | 292/341.18 |
| 2,643,149 A | June 1953 | Mager | E05B 15/0245 |
| | | | 292/340.18 |
| 2,650,848 A | September 1953 | Garbs | E05B 15/02 |
| | | | 292/341.18 |
| 2,678,843 A | May 1954 | Steffan | E05B 15/02 |
| | | | E05B 15/0245 |
| | | | 292/341.18 |
| 2,695,807 A | November 1954 | Bissot | E05B 15/0245 |
| | | | 292/341.18 |
| 2,695,808 A | November 1954 | Manchester | E05B 15/0245 |
| | | | 292/341.18 |
| 2,713,506 A | July 1955 | Wickstrom | E05B 15/0245 |
| | | | 292/341.18 |
| 2,781,219 A | February 1957 | Bahorik | E05B 15/02 |
| | | | 292/341.18 |
| 2,787,490 A | April 1957 | Gravino | E05B 15/0245 |
| | | | 292/340.18 |
| 2,798,754 A | July 1957 | Russell | E05B 15/0245 |
| | | | 292/341.18 |
| 2,863,692 A | December 1958 | Mann | E05B 15/024 |
| | | | 292/340.18 |
| 2,899,227 A | August 1959 | Gschwend | E05C 1/12 |
| | | | 292/163 |
| 2,946,614 A | July 1960 | Russell | E05B 15/0205 |
| | | | 292/341.11 |
| 2,990,211 A | June 1961 | Wartian | E05B 15/02 |
| | | | 292/341.18 |
| 2,993,719 A | July 1961 | Manchester | E05B 15/0255 |
| | | | 292/341.18 |
| 3,006,677 A | October 1961 | Royalty | E05B 15/0245 |
| | | | 292/341.18 |
| 3,057,053 A | October 1962 | Schlage | E04F 21/003 |
| | | | 29/407.01 |
| 3,095,724 A | July 1963 | Truhon | E05B 55/00 |
| | | | 70/146 |
| 3,161,429 A | December 1964 | Tornoe et al. | E05B 15/025 |
| | | | 292/341.18 |
| 3,241,873 A | March 1966 | Russell | E05B 15/0205 |
| | | | 292/340 |
| 3,245,709 A | April 1966 | Rosenberger | E05B 15/02 |
| | | | 292/340 |
| 3,257,139 A | June 1966 | Russell | E05B 15/0245 |
| | | | 292/341.18 |
| 3,265,427 A | August 1966 | Williams | E05B 15/0245 |
| | | | 292/341.18 |
| 3,287,055 A | November 1966 | Schlage | E05B 15/0255 |
| | | | 292/341.12 |
| 3,316,007 A | April 1967 | Russell | E05B 15/0255 |
| | | | 292/341.12 |
| 3,318,123 A | May 1967 | Piazza | E05B 17/2042 |
| | | | 70/447 |
| 3,361,466 A | January 1968 | Russell | E05B 15/0245 |
| | | | 292/341.18 |
| 3,395,935 A | August 1968 | Rosenberger | E05B 15/0245 |
| | | | 292/341.13 |
| 3,401,487 A | September 1968 | Brandt et al. | E06B 1/20 |
| | | | 49/504 |
| 3,416,829 A | December 1968 | Russell | E05B 15/0245 |
| | | | 292/341.18 |
| 3,454,295 A | July 1969 | Schlage et al. | E05B 15/02 |
| | | | 292/341.18 |
| 3,506,293 A | April 1970 | Russell et al. | E05B 15/02 |
| | | | 292/341.19 |
| Des. 220,423 | April 1971 | Dugan | D8/03 |
| | | | D8-117 |
| 3,601,078 A | August 1971 | Bedford | B63B 39/061 |
| | | | 114/271 |
| 3,606,429 A | September 1971 | Palmer | E05B 15/02 |
| | | | E05B 17/20 |
| | | | E05B 17/2003 |
| | | | 292/340 |
| 3,610,668 A | October 1971 | Tixier | E05B 85/24 |
| | | | 292/341.12 |
| 3,801,143 A | April 1974 | Gutner | E05C 19/06 |
| | | | 292/76 |
| 3,806,176 A | April 1974 | Massie | E05C 1/16 |
| | | | E05C 1/16 |
| | | | 292/150 |
| 3,815,945 A | June 1974 | Lamphere | E05C 19/00 |
| | | | 292/340 |
| 3,825,289 A | July 1974 | Armstrong | E05B 15/0205 |
| | | | 292/163 |
| 3,831,988 A | August 1974 | Stelma | E05F 7/04 |
| | | | 292/302 |
| 3,966,248 A | June 1976 | James | E05B 15/0205 |
| | | | 292/340 |
| 4,017,106 A | April 1977 | Salazar | E05C 19/00 |
| | | | 292/340 |
| 4,105,235 A | August 1978 | Thiel | E05B 15/0245 |
| | | | 292/341.18 |
| 4,113,293 A | September 1978 | Paquette | E05C 21/02 |
| | | | E05B 15/02 |
| | | | E05B 15/025 |
| | | | 292/341.18 |
| 4,126,343 A | November 1978 | Ragland | E05C 13/00 |
| | | | 292/341 |
| 4,171,836 A | October 1979 | St. Aublin | E05C 19/00 |
| | | | 292/341.18 |
| 4,181,338 A | January 1980 | Sterling | E05B 15/022 |
| | | | 292/341.17 |
| 4,189,175 A | February 1980 | Paxton | E05B 15/02 |
| | | | 292/340 |
| 4,186,954 A | February 1980 | Detlefs | E05C 13/00 |
| | | | 292/340 |
| 4,195,870 A | April 1980 | Percoco | E05C 13/00 |
| | | | 292/340 |
| 4,218,084 A | August 1980 | Musacchia | E05C 13/00 |
| | | | 292/341.19 |
| 4,288,120 A | September 1981 | Moore | E05B 15/025 |
| | | | 292/341.18 |
| Des. 261,478 | October 1981 | Gauntt | D8-07 |
| | | | D8/344 |
| Des. 261,225 | October 1981 | Sterling | D8-07 |
| | | | D8/1344 |
| Des. 263,675 | April 1982 | Vorves | D8-07 |
| | | | D8/343 |
| 4,065,162 A | August 1982 | Schlage | E05B 15/02 |
| | | | E05C 21/02 |
| | | | E05B 15/0205 |
| | | | 292/340 |
| 4,369,994 A | January 1983 | Vorves | E05C 21/02 |
| | | | 292/340 |
| 4,379,577 A | April 1983 | Robertson | E05C 13/02 |
| | | | 292/341.15 |
| 4,429,495 A | February 1984 | Aoki | E05B 15/0225 |
| | | | 292/341.11 |
| 4,453,751 A | June 1984 | Hamilton | E05C 13/00 |
| | | | 292/340 |
| 4,453,752 A | June 1984 | McKann | E05B 15/02 |
| | | | 292/341.19 |
| 4,466,645 A | August 1984 | Kobayashi | E05B 85/045 |
| | | | 292/216 |
| 4,492,397 A | January 1985 | Allenbaugh | E05C 13/00 |
| | | | 292/341.18 |
| 4,550,939 A | November 1985 | Babb et al. | E05C 21/02 |
| | | | 292/340 |
| Des. 283,299 | April 1986 | Mazie | D8/343 |
| | | | 292/340 |
| 4,665,596 A | May 1987 | Green | A44B 11/125 |
| | | | 220/283 |
| 4,802,701 A | February 1989 | Mazie | C05C 21/00 |
| | | | 292/340 |
| 4,813,724 A | March 1989 | Dietrich | E05B 15/022 |
| | | | 292/341.12 |
| 4,892,341 A | January 1990 | Dietrich | E05B 15/022 |
| | | | 292/341.12 |
| 4,893,854 A | January 1990 | Dietrich | E05B 15/022 |
| | | | 292/341.12 |
| 4,991,888 A | February 1991 | Cinnamond | E05C 19/18 |
| | | | 292/288 |
| 5,016,930 A | May 1991 | Hamilton | E05B 15/0205 |
| 5,028,083 A | July 1991 | Mischenko | E05C 1/10 |
| | | | 248/222.12 |
| 5,031,943 A | July 1991 | Scott | B65D 33/34 |
| | | | 292/307 R |
| 5,094,489 A | March 1992 | Jones | E05C 21/02 |
| | | | 292/340 |
| 5,118,151 A | June 1992 | Nicholas, | E05R 15/02 |
| | | Jr. et al. | 292/341.19 |
| 5,127,690 A | July 1992 | Kim et al. | E05B 17/00 |
| | | | 292/340 |
| 5,171,050 A | December 1992 | Mascotte | F05L 21/02 |
| | | | 292/341.18 |
| Des. 339,056 | September 1993 | Black | D8/344 |
| | | | 292/340 |
| 5,613,718 A | March 1997 | Lin | F05B 17/00 |
| | | | 292/346 |
| 4,813,724 A | March 1989 | Dietrich | E05B 15/02 |
| | | | 292/341.12 |
| 5,757,269 A | May 1998 | Roth | E05B 45/06 |
| | | | 340/542 |
| 5,897,147 A | April 1999 | Alyanakian | E05B 17/0004 |
| | | | 292/153 |
| 5,974,842 A | November 1999 | Schlack | E05B 17/0004 |
| | | | 292/153 |
| 5,975,593 A | November 1999 | Cress | E05B 53/001 |
| | | | 292/101 |
| 6,085,465 A | July 2000 | Olberding et al. | E05B 1/00 |
| | | | 49/460 |
| 6,089,627 A | July 2000 | Pearson | E05B 15/02 |
| | | | 292/341.18 |
| 6,318,772 B1 | November 2001 | Pearson | E05B 15/02 |
| | | | 292/341.18 |
| 6,430,876 B1 | August 2002 | Allen et al. | E06B 3/30 |
| | | | 49/360 |
| 6,471,265 B1 | October 2002 | Scott, Sr. | E05B 15/02 |
| | | | 292/341.15 |
| 2003/0057718 A1 | March 2003 | Stoehr | E05B 15/02 |
| | | | 292/340 |
| 6,588,155 B1 | July 2003 | Theune et al. | E06B 1/20 |
| | | | 49/504 |
| 2003/052492 A1 | March 2003 | Massey | E05B 15/02 |
| | | | E05C 1/04 |
| 2003/0137155 A1 | July 2003 | Baranski | E05B 15/02 |
| | | | 292/341.18 |
| 6,637,096 B2 | October 2003 | Kang | E05B 15/0205 |
| | | | 29/11 |
| 6,641,185 B2 | November 2003 | Hale | E05C 19/18 |
| | | | 292/289 |
| 2004/0164565 A1 | August 2004 | Wagner et al. | E05B 15/02 |
| | | | 292/340 |
| 6,834,897 B1 | December 2004 | Walker | E05B 15/02 |
| | | | 292/340 |
| 6,857,672 B1 | February 2005 | Drew, II | E05B 15/0205 |
| | | | 292/340 |
| 2005/0134061 A1 | June 2005 | Milo | E05B 15/02 |
| | | | 292/340 |
| 2005/0134061 A1 | June 2005 | Sanders | E05B 15/02 |
| | | | 292/340 |
| 7,000,959 B2 | February 2006 | Sanders | E05B 15/02 |
| | | | 292/340 |
| 2006/0145487 A1 | July 2006 | Wilder | E05B 15/02 |
| | | | 292/340 |
| 2006/0157991 A1 | July 2006 | Nguyen | E05B 15/02 |
| | | | 292/340.18 |
| 2006/0249970 A1 | November 2006 | Wilder et al. | E05B 15/02 |
| | | | 292/340 |
| 2007/0040397 A1 | February 2007 | Nicholas, | E05B 15/02 |
| | | Jr., et al. | 292/341.18 |
| 2007/0029823 A1 | February 2007 | Gatrell | E05B 15/02 |
| | | | 292/340 |
| 2007/0029822 A1 | February 2007 | Monts de Oca | E05B 15/02 |
| | | | 292/340 |
| 2007/0096480 A1 | May 2007 | Arneson et al. | E05B 15/02 |
| | | | 292/340 |
| 7,240,931 B1 | July 2007 | Casey | E05B 15/02 |
| | | | 292/341.18 |
| 2008/0252085 A1 | October 2008 | Langtry | E05B 15/02 |
| | | | 292/340 |
| 2008/0265590 A1 | October 2008 | Bodily et al. | E05B 15/02 |
| | | | 292/340 |
| 2009/0250951 A1 | October 2009 | Rodriguez | E05B 15/02 |
| | | | E04G 21/00 |
| | | | 292/340 |
| 7,686,356 B2 | March 2010 | Wilder | E05B 15/022 |
| | | | 292/340 |
| 2010/0282138 A1 | November 2010 | Canardy, Jr. | E06B 5/10, |
| | | | 3/04, 1/04 |
| | | | E05B 15/02 |
| | | | 109/77 |
| 2011/0175378 A1 | July 2011 | Gosterisli | E05B 15/02 |
| | | | B23P 11/00 |
| | | | 292/341.19 |
| 2011/0309643 A1 | December 2011 | Pope | E05B 15/02 |
| | | | B26F 1/38 |
| | | | 292/340 |
| 8,287,010 B 2 | October 2012 | Holzer | E05B 15/02 |
| | | | 292/341.16 |
| 8,491,020 B2 | July 2013 | Lopes | B60D 1/60 |
| | | | 292/1 |
| 2002/0008391 A1 | January 2002 | Patton | E05C 19/06 |
| | | | 292/341.17 |
| 6,834,897 B1 | December 2004 | Walker | E05B 15/02 |
| | | | 292/340 |
| 2006/0202486 A1 | September 2006 | Graute | E05B 77/38 |
| | | | 292/216 |
| 2007/0040397 A1 | February 2007 | Nicholas | E05B 15/0245 |
| | | | 292/341.18 |
| 7,686,356 B2 | March 2010 | Wilder et al. | E05B 17/00 |
| | | | 292/340 |
| 2012/0286527 A1 | November 2012 | Mullet | E05B 15/02 |
| | | | 292/341.18 |
| 2015/0204107 A1 | July 2015 | Sweeten | E05B 15/02 |
| | | | 292/340 |
| 9,223,355 B2 | December 2015 | Kwang Ho Kim | E05C 1/02 |
| | | | G06F 1/1679 |
| 2016/0115710 A1 | April 2016 | Bunch | E05B 15/02 |
| | | | E05B 15/0205 |
| 2016/0177611 A1 | June 2016 | Rissone | E05F 5/02 |
| | | | 267/139 |
| 9,422,742 B2 | August 2016 | Pardoe | E05B 15/0205 |
| | | | E05B 17/007 |
| | | | E05B 15/02 |
| 2016/0305156 A1 | October 2016 | Kamody et al. | E05B 15/02 |
| | | | E05B 15/024 |
| 2016/0069105 A1 | March 2016 | Magee | E05B 15/02 |
| | | | E05B 15/025 |
| 9,493,964 B1 | November 2016 | Torrens | E05B 15/024 |
| | | | 292/340 |
| 2016/034396 A | December 2016 | Hunt | E05B 15/0205 |
| D777,558 S | January 2017 | Magee | D8/344 |
| 2017/0175417 A1 | June 2017 | Sweeten | E05B 15/02 |
| | | | 0205, 0225 |
| 9,822,550 B2 | November 2017 | Fenwick | E05B 15/02 |
| | | | 292/341.18 |
| 2018/0066449 A1 | March 2018 | Kamody | E05B 15/02 |
| | | | 292/341.18 |
| 2018/0073272 A1 | March 2018 | Fenwick | E05B 15/02 |
| | | | 292/341.18 |
| 10,227,794 B1 | March 2019 | Martin, Jr. | E05B 15/205 |
| | | | 292/289 |
| 2019/0376314 A1 | December 2019 | Song | E05B 15/02 |
| | | | E05B17/00 |
| | | | E05B15/0205 |
| | | | E05B17/0045 |
| 10,544,602 B1 | January 2020 | Alvarado | E05B 15/02 |
| 2020/0011126 A1 | January 2020 | Goldense | E06B 5/16 |
| | | | E06B 5/164 |
| 2020/0032546 A1 | January 2020 | Heid | E05B 15/02 |
| | | | E05B 15/024 |

### Foreign Patent Documents

| | | | |
|---|---|---|---|
| GB | 190,905,762 A | March 1909 | E05B 15/0205 |
| FR | 510,385 A | February 1920 | E05B 15/02 |
| | | | E05B 15/0245 |
| FR | 605,232 A | July 1925 | E05B 15/022 |
| GB | 430,369 A | February 1934 | E05B 63/22 |
| GB | 475,898 A | May 1936 | E05B 15/02 |
| | | | E05B 15/0245 |
| GB | 481,989 A | November 1936 | E05C 16 |
| | | | E05C 3/162 |
| GB | 505,236 A | January 1938 | E05B 15/02 |
| | | | E05B 15/0245 |
| GB | 688,749 A | August 1951 | E05B 15/0245 |
| GB | 1,077,609 A | December 1965 | E05B 15/025 |
| DE | 2263702 A1 | July 1974 | E05B 15/0205 |
| FR | 2355978 A1 | January 1978 | E05B 15/0225 |
| AU | 551,092 B2 | December 1981 | E05B 15/02 |
| FR | 2525269 B1 | April 1982 | E05B 15/02 |
| JP | S59,177,665 U | May 1983 | E05B 15/02 |
| GB | 2177153 B | July 1985 | E05B 15/02 |
| GB | 2168747 A | November 1985 | E05B 15.02 |
| | | | E05B 15/0245 |
| EP | 0,201,244 A2 | December 1986 | E05B 15/02 |
| GB | 2228291 A | February 1990 | E05B 15/02 |
| GB | 2243400 A | April 1990 | E05B 15/02 |
| GB | 2245305 A | June 1990 | E05B 15/02 |
| | | | E05B 15/0245 |
| GB | 2230294 A | October 1990 | E05B 15/02 |
| | | | E05B 15/025 |
| JP | H07173958 A | December 1993 | E05B 15/02 |
| JP | H07247739 A | March 1994 | E05B 15/02 |
| EP | 0,663,496 A3 | January 1995 | E05B 15/0245 |
| | | | E05B 15/025 |
| JP | H08296353 A | April 1995 | E05B 15/02 |
| JP | H08319740 A | April 1995 | E05B 15/02 |
| JP | 07,043,474 U | August 1995 | E05B 15/02 |
| JP | H10102839 A | September 1996 | E05B 15/02 |
| JP | H10148046 A | September 1996 | E05B 15/02 |
| JP | H10184116 A | December 1996 | E05B 15/02 |
| JP | 2001329723 A | May 2000 | E05B 15/02 |
| EP | 1,113,127 A1 | July 2001 | E05B 15/022 |
| GB | 2361960 B | August 2001 | E05B 15/02 |
| JP | 2004124508 A | October 2002 | E05B 15/02 |
| DE | 10,216,718 A1 | October 2003 | E05B 15/0205 |
| JP | 3,111,290 U | July 2005 | E05B 15/02 |
| WO | 2007006076 A1 | July 2006 | E05B 15/024 |
| | | | E05B 15/025 |
| EP | 1,703,043 A2 | September 2006 | E05B 15/0205 |
| JP | 2008179976 A | January 2007 | E05B 15/02 |
| JP | 2008274554 A | April 2007 | E05B 15/02 |
| JP | 2008274645 A | April 2007 | E05B 15/02 |
| JP | 2010150769 A | December 2008 | E05B 15/02 |
| KR | 20090004785 U | May 2009 | E05B 15/00 |
| | | | E05B 15/02 |
| JP | 2010070948 A | February 2010 | E05B 15/02 |
| EP | 10,730,146 A | June 2010 | E05B 15/02 |
| GB | 2472271 A1 | February 2011 | E05B 15/0205 |
| EP | 2694763 A1 | April 2011 | E05B15/024 |
| KR | 20140002798 A | April 2012 | E05B 15/02 |
| | | | E05B 15/0245 |
| JP | 2015010398 A | June 2013 | E05B 15/02 |
| JP | 2010084424 A1 | December 2012 | E05B 15/02 |
| EP | 2878748 B1 | November 2014 | E05B 15/0245 |
| JP | 6,243,153 B2 | January 2005 | E05B 15/02 |
| JP | 2015010398 A | January 2015 | E05B 15/02 |
| CN | 107,327,222 A | August 2017 | E05B 15/02 |
| | | | E05B 15/025 |
| CN | 107,327,223 A | August 2017 | E05B 15/02 |
| | | | E05B 14/025 |
| KR | 102,063,403 B1 | August 2018 | E05B 15/02 |
| | | | E05B 15/025 |
| WO | 2019/199066 A1 | October 2019 | E05B 17/00 |

### EXHIBIT 2. TERMINOLOGY OF NUMBERED ACCESSORIES IN THE DRAWINGS DESCRIBING THE PREFERRED EMBODIMENTS

100 Edge strike latch plate
110 Upper edge
120 Lower edge
130 Rear edge
140 Retraction means, front edge striker
142 Flat edge
144 Beveled edge
146 Rounded edge
148 Flange
170 Adjustable tab
180 Opening for receiving a spring-loaded latch bolt
190 Upper aperture
192 Lower aperture
200 Door jamb
210 Front edge of a door jamb
220 Rear edge of a door jamb
230 Drilled hole of a door jamb for receiving a spring-loaded latch bolt
300 Door stop
400 Architrave
410 Front edge of architrave
420 Rear edge of architrave
500 Dry wall
600 Stud

1. A door jamb latch plate comprising:
a flat base member having an upper edge, a lower edge, a rear edge, a front edge, and a truncated retraction means for retracting an angled bolt of a door spring-loaded latch bolt mechanism and for protecting from injury or damage individuals, clothing, personal property, and pets;
said flat base member having an opening for receiving the angled bolt of the door spring-loaded latch bolt mechanism;
said flat base member having a plurality of fastener openings for securing said flat base member to a door jamb;
said flat base member having said front edge situated at a front edge of the door jamb for protecting from injury or damage individuals, clothing, personal property, and pets;
said truncated retraction means situated at the front edge of the flat base member for protecting from injury or damage individuals, clothing, personal property, and pets;
said truncated retraction means situated at the front edge of the door jamb for protecting from injury or damage individuals, clothing, personal property, and pets; and
said truncated retraction means situated parallel to the front edge of the door jamb.

2. (canceled)

3. (canceled)

4. The door jamb latch plate according to claim 1 further including
an adjustable tab integral to said flat base member for guiding the angled bolt of the door spring-loaded latch bolt mechanism to said opening for receiving the angled bolt of the door spring-loaded latch bolt mechanism.

5. (canceled)

6. (canceled)

7. (canceled)

8. (canceled)

9. (canceled)

10. (canceled)

11. A door jamb latch plate comprising:
a flat base member having an upper edge, a lower edge, a rear edge, a front edge, and a truncated striker selected from the group consisting of a flat edge, a beveled edge, a rounded edge, and a flange;
said truncated striker for retracting an angled bolt of a door spring-loaded latch bolt mechanism and for protecting individuals, clothing, personal property, and pets from injury or damage;
said flat base member having an opening for receiving the angled bolt of the door spring-loaded latch bolt mechanism;
said flat base member having a plurality of fastener openings for securing said flat base member to a door jamb;
said flat base member having said front edge situated at a front edge of the door jamb for protecting from injury or damage individuals, clothing, personal property, and pets;
said truncated striker situated at the front edge of the door iamb for protecting from injury or damage individuals, clothing, personal property, and pets;
said truncated striker situated at the front edge of the door jamb for protecting from injury or damage individuals, clothing, personal property, and pets; and
said truncated striker situated parallel to the front edge of the door jamb.

12. (canceled)

13. (canceled)

14. (canceled)

15. The door jamb latch plate according to claim 11 further including
an adjustable tab integral to said flat base member for guiding the angled bolt of the door spring-loaded latch bolt mechanism to said opening for receiving the angled bolt of the door spring-loaded latch bolt mechanism.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)
